(19) United States
(12) Patent Application Publication
(10) Pub. No.: US 2008/0097882 A1
(43) Pub. Date: Apr. 24, 2008

(54) System and method for optimizing the use of credit resources

(76) Inventors: Rick Rowe, Las Vegas, NV (US); Stephen Moore, Las Vegas, NV (US); Carolyn Leveque, Las Vegas, NV (US)

Correspondence Address: WEIDE & MILLER, LTD., 7251 W. LAKE MEAD BLVD., SUITE 530, LAS VEGAS, NV, 89128, US

(21) Appl. No.: 11/880,183

(22) Filed: Jul. 19, 2007

Related U.S. Application Data
(60) Provisional application No. 60/832,475, filed on Jul. 20, 2006.

(51) Int. Cl. G06Q 40/00

(52) U.S. Cl. 705/35

(57) ABSTRACT

A system and method is provided for optimizing the use of credit resources. A financial system includes a database which stores customer credit/debit account information and use-consequence preference information. A master financial card is issued to the customer for all credit transactions. A host server receives information regarding the use of the master financial card and communicates with the database of information to decide the optimum credit card/account to which the purchase is to be applied.

### RELATED APPLICATION DATA

This application claims priority to U.S. Provisional Application Ser. No. 60/832,475, filed Jul. 20, 2006.

### TECHNICAL FIELD

This invention relates generally to credit purchases, and, more specifically, to a system and method that optimizes the use of credit resources when making a purchase.

### BACKGROUND OF THE INVENTION

The vast majority of consumers in the United States make purchases on credit. Recent surveys have revealed that approximately 144 million consumers have a credit card and that an average household has collectively approximately ten credit cards. Two out of the ten credit cards are likely to be co-branded loyalty cards. Even with the variety of cards that a consumer possesses and the choices thus presented, the typical consumer prefers one credit card over the others and uses that card over seventy percent of the time.

It can be appreciated that each of the individual cards carried by a consumer may offer different credit terms, and, in addition, may offer different discounts, promotions and/or rewards as a consequence of use. Thus, with all of the differences offered by each individual card, there is likely to be a “best” card to use when making a particular purchase at a particular time. However, various factors, including time constraints and decision pressures, generally prevent the consumer from determining which among the credit cards in his or her possession is the optimum card to use for that particular propose.

It is desired to create a financial system that facilitates the optimal use of credit resources when making a purchase. The system and method described below satisfies this desire and provides additional advantages and benefits.

### SUMMARY OF THE INVENTION

The present invention comprises a system and method for optimizing the use of credit or other financial resources.

In one embodiment, the system includes a database of customer information. This information may include information regarding a customer's various credit or financial accounts and use-consequence preference information. Use-consequence preference information may be the order of credit account use desired by the customer, whether the customer prefers to accumulate partner points, utilize a card for the opportunity to have free shipping of merchandise, or secure the opportunity to receive a cash back bonus.

Preferably, a master financial card is issued to the customer/member. The master financial card is designed for use for each credit transaction. The use of the master financial card eliminates the need for the customer/member from having to carry other cards and thus decide which particular credit card among those in his or her possession to present to facilitate a transaction.

The system further comprises a decision processor. When a customer utilizes the master card or other card (or account) which is associated with the system, that contemplated transaction is communicated to the financial system. The decision processor utilizes the customer's account and user-consequence information to provide information regarding a preferred credit/account use decision. In one embodiment, that information is transmitted to the customer. In another embodiment, the transaction is completed based upon that decision.

The decision processor may be configured to make a decision based upon various criteria. Those criteria may include available credit, APR, rewards points or the like. The customer may elect preferences, such as a desire to focus upon debt reduction or rewards accumulation, to be effected by the decision processor.

Other advantages of the present invention will become apparent to those skilled in this art from the following description wherein there is shown and described an embodiment of this invention, simply by way of illustration of the modes best suited to carry out the invention. As will be realized, the invention is capable of other different embodiments and its several details are capable of modification in various, obvious aspects all without departing from the invention. Accordingly, the drawings and descriptions will be regarded as illustrative in nature and not as restrictive.

### BRIEF DESCRIPTION OF THE DRAWINGS

The accompanying drawings incorporated in and forming a part of this specification illustrate several aspects of the present invention and together with the description serves to explain the principles of the invention. In the drawings:

FIG. 1 is a block diagram of an example embodiment of the financial system of the present invention;

FIG. 2 is an operational flow diagram of an exemplary method of operation of the present invention; and

FIG. 3 is an operational flow diagram of an alternate exemplary method of the operation of the present invention.

Reference will now be made in detail to various embodiments of the invention, an example of which is illustrated in the accompanying drawings.

### DETAILED DESCRIPTION OF THE INVENTION

In the following description, numerous specific details are set forth in order to provide a more thorough description of the present invention. It will be apparent, however, to one skilled in the art, that the present invention may be practiced without these specific details. In addition, various features described herein may be enabled alone or in combination. In other instances, well-known features have not been described in detail so as to not obscure the invention.

The vast majority of consumers have opened credit accounts that are used to make a variety of purchases. The use of such credit resources has given consumers tremendous freedom in being able to make large purchases as well as everyday items when the consumer may not have sufficient cash to buy items as desired. Most consumers have a plurality of credit cards, but are unable to chose the best card at the time of purchase for variety of reasons. The present invention contemplates a financial system that aids the consumer in making a decision, or makes such a decision for the consumer, at the point of purchase as to which among the credit accounts in the consumer's family of open accounts is the best to which to apply the purchase. The decision is based on any one or more of a number of factors as will be described in more detail below.

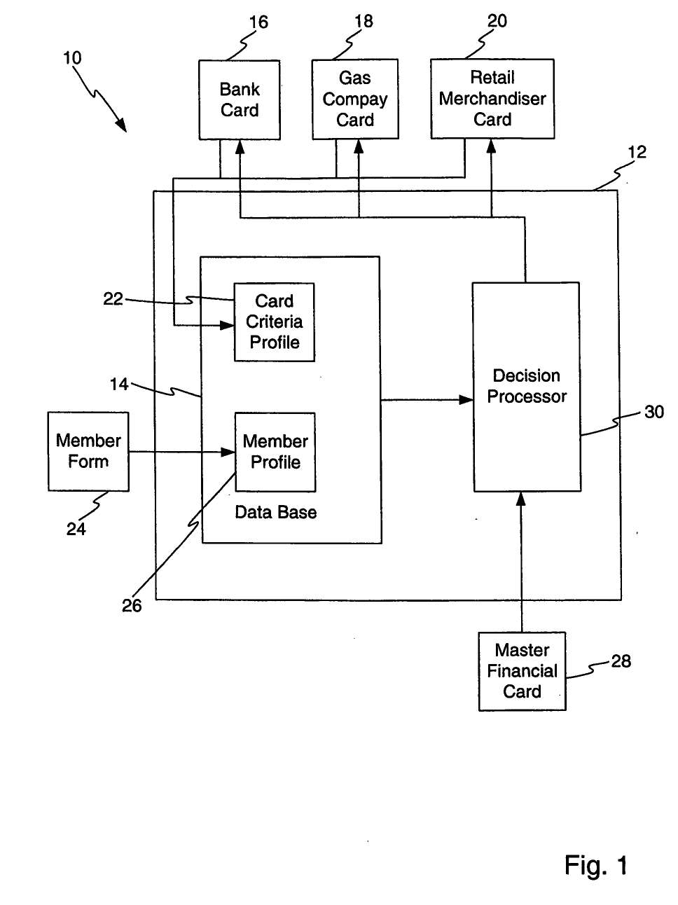

Referring to FIG. 1, the financial system 10 may comprise a host server or computer 12. It is contemplated that once a customer registers with the system, he or she may become a member of the system to utilize all of the various services offered by the system. Herein, the terms “customer”, “member” and “customer/member” may be used interchangeably.

The host server 12 may have a variety of configurations. In one embodiment, the host server 12 includes at least one processor for executing commands, such as computer readable program code. The host server 12 preferably also includes one or more information or data storage devices, such as hard drives, RAM, ROM or other electronic memory elements. Though not illustrated, the host server 12 may communicate with various other devices, such as remote computers, via one or more communication interfaces. As detailed below, for example, party may enroll or register with the system by establishing a communication link from a home or work computer to the host server 12. This communication link may be wired or wireless or combinations thereof, and may include the World Wide Web.

In one embodiment, the host server 12 includes or can communicate with database 14. The database 14 preferably comprises information that includes, without limitation, information regarding a member's individual credit accounts and information on use-consequence preferences, the meaning of which will become clear with further description below. The database 14 may be associated with one or more data storage devices, such as a memory of the host server 12.

The individual credit accounts of a customer/member may be of any of a variety of credit sources or types. In FIG. 1, three categories of credit sources are identified. In the diagram, credit card elements like those known in the art and typically carried by a consumer are shown as representing credit accounts that are registered with the financial system 10 by the customer/member. It should be realized, however, that sources of credit other than those illustrated in FIG. 1 may be established by a customer/member and that reference to either a credit account or a card for use with that credit account may identify a particular source of credit for the customer/member.

The credit sources defining the credit accounts illustrated in FIG. 1 include a bank card/account 16, a gas company card/account 18 and a retail merchandiser card/account 20. As an example of each, the bank card/account 16 may be represented by a Visa® credit card, the gas company card/account 18 may be represented by an Exxon® credit card and the retail merchandiser card/account 20 may be represented by a Sears® credit card. It can be appreciated that the gas company card/account 18 generally offers a customer the ability to make purchases, such as gasoline, from participating gas stations. The retail merchandiser card/account offers the customer the ability to make retail purchases from participating stores, such as particular retail store or chain, such as Sears®. The bank card/account 16 generally offers the customer the ability to make purchases at a wide variety of locations, including not only gas stations and retail establishments, but also restaurants and entertainment venues.

It will be appreciated that the customer's accounts may include other financial accounts. Such accounts may include a customer's debit accounts (such as a bank card linked to the customer's checking account). The term “credit” as used herein is thus contemplated as encompassing such other types of financial accounts unless otherwise stated.

As is commonly known, each of the individual credit accounts 16, 18 and 20, having been established by a different entity, may have different terms regarding their use, such as payment schedule, annual percentage rate (APR), balance maintenance, minimum payment requirements and service fees. In addition, the various credit accounts 16, 18 and 20 may offer reward opportunities and consumer-targeted promotions, each of which may be substantially different from the others. It can thus be appreciated that the use of a particular credit account in making a particular purchase may be desirable as compared with any other credit account opened by the customer/member. As mentioned above, it may not be feasible to determine at the time of purchase which among the available credit accounts is the optimum one to apply the purchase.

In accordance with the invention, the financial system 10 is configured to aid in making these decisions. In one embodiment, a customer registers their credit accounts 16, 18 and 20 with the financial system 10 to create a card criteria profile 22 comprising information regarding the individual accounts. The card criteria profile 22 may be used by the financial system 10 in the decision-making process mentioned above.

It is contemplated that, as part of the registration process for joining and later using the financial system 10, the customer may fill out a member form 24 that creates a member profile 26 that is stored in the database 14 of the master financial system 10. The member profile 26 desirably includes use-consequence preference information provided by and associated with the customer/member who fills out the related form 24. For example, the use-consequence information may comprise the order in which a customer/member desires to utilize his or her various credit accounts to optimize the opportunity to receive one or more rewards offered in association with the use of those credit accounts. These can include, without limitation, cash back bonuses, partner promotions such as airline miles and/or free hotel stays, double and triple account points and the like. In establishing the member profile 26, the customer will prioritize these various use-consequences to establish a preference hierarchy that may be implemented by the financial system 10 at the time a purchase is made.

It will be appreciated that the member form may be paper or electronic. For example, a customer may be permitted to access a web-site supported by the host server 12. The customer may enter information into fields of the website, which information is provided to the host server 12. This information may comprise, for example, account numbers and expiration dates, account provider names and the like. As also mentioned, the customer preferably also provides information identifying themselves (member profile information). This information may comprise, but is not limited to, the customer's name, address and phone number.

It will also be appreciated that various of the services offered by the financial system may be “pay” services. For example, a customer may pay a monthly service fee to utilize the financial system. In other configuration, the financial system operator may charge or apply a transaction fee to each financial transaction which is affected by or through the system.

In a preferred embodiment of the invention, the financial system 10 includes a master financial card 28. The master financial card 28 (which may comprise a plastic card with associated magnetic stripe or other media, such as smart card, RFID or other element) is issued to a customer/member as single card to use for a credit transaction. Thus, the customer/member is freed from having to make an on-the-spot decision as to which credit card among those in his or her possession to use for any particular transaction. When the master financial card 28 is presented when making a purchase, the host server 12 of the financial system 10 is alerted in accordance standard notification protocol as is known in the art. The financial system 10 processes the transaction as would any of the individual credit sources do in the present state of the art. In other embodiments, the customer may simply be assigned a master financial account, and the user may utilize various devices or elements, whether such is a “card” or other device, for effecting payment/financial account information transfer, such as a cell/mobile phone or personal data device (PDA) relative to that master account.

A key aspect of the financial system 10 of the present invention is a decision processor 30. The decision processor 30 may be housed and supported in the host server 12 of the master financial system 10 or, alternatively, may be a stand-alone element of the system. The decision processor 30 cooperates with the database 14 and the master financial card 28 to perform the function of deciding which among the customer/member's individual credit accounts is the optimum or preferred account to which a purchase is to be applied. The decision processor 30 processes the information comprising the card criteria profile 22 and the member profile 26 in making the determination as to the optimum choice of credit accounts.

The decision-making process is contemplated as occurring along either of several decision tracks. There may be a category of customer/members whose preferential use of credit accounts is based on the terms established for each of the credit accounts, like the payment terms and APR as mentioned above. There may also be another general category of customer/members who preferential use of credit accounts is based on the rewards that are granted to them for the use of a credit account when in a credit transaction. Of course, there may be yet other categories of customers/members.

The first category of customer/members mentioned above can be broadly described as being in classifications identified in the art as either Credit Users or Debt Reducers. Consumers in each of these card holder classifications generally desire a sufficient credit line to allow them to make purchases of any kind, in any amount and at any time. Their primary concern is to apply the purchase to the appropriate credit account(s) that maximizes their credit availability and minimizes their monetary outlay.

The other category of customer/members may be generally be described, as alluded to above, as Reward Seekers. Consumers in this card holder category have as their primary credit use concern the best-choice rewards they receive from use of their credit accounts. To achieve this goal, Reward Seekers often seek to leverage special promotions for multiple return opportunities. Examples of their interest may include double and triple points for certain types of purchases or transactions.

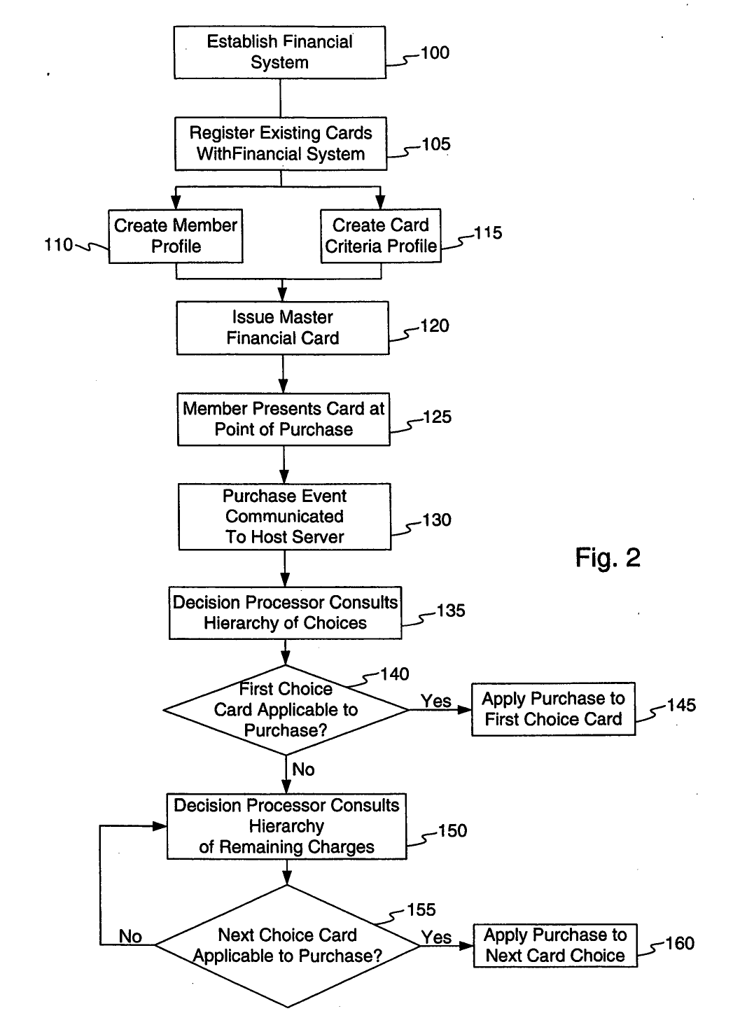

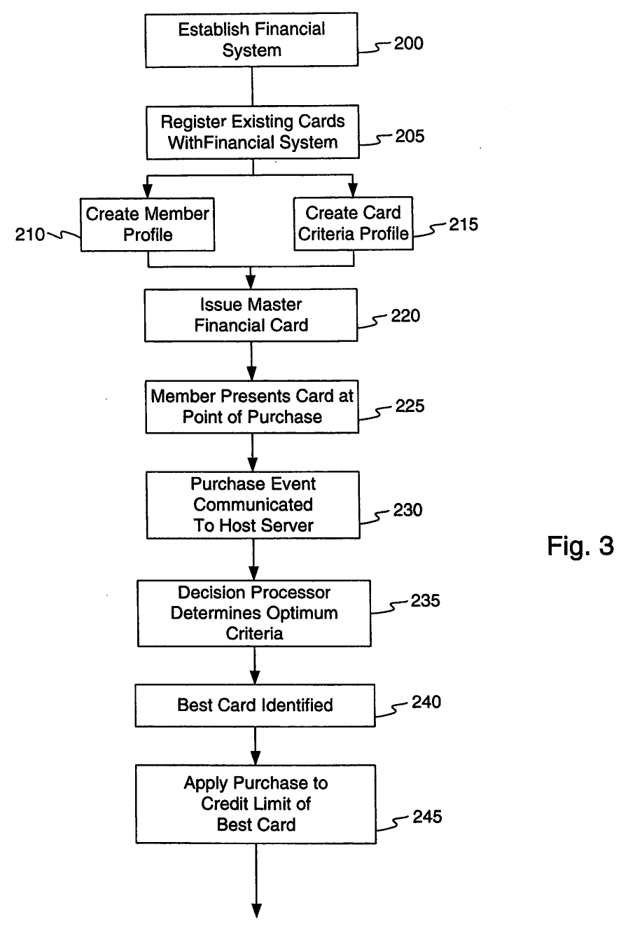

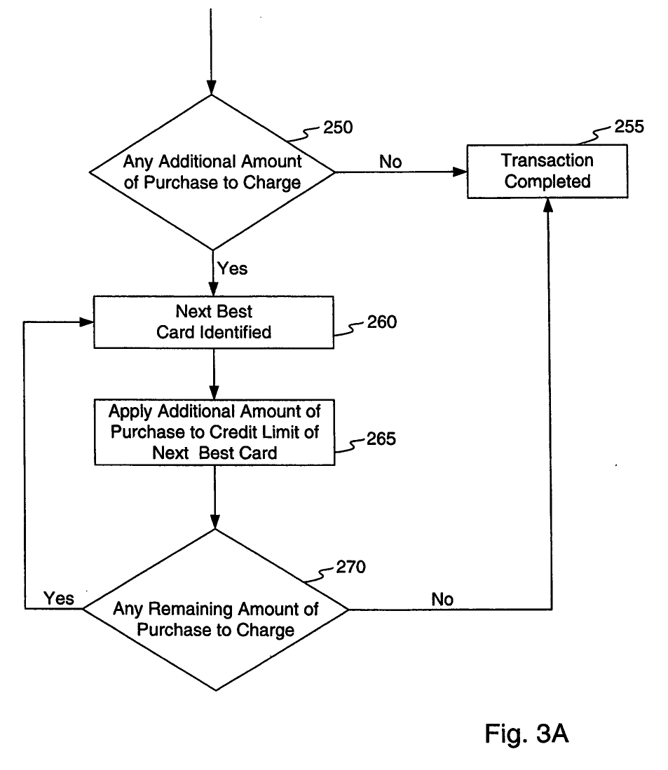

Further details regarding the financial system 10, including its method of operation, will be described with reference the operational flow diagram illustrated in FIGS. 2 and 3-3A. These diagrams illustrate financial system operation, including decisional operations, which may be implemented by the system 10. It will be appreciated that the decisional operations may be effected by execution of computer readable code or other operation of a processor of the host server 12.

FIG. 2 illustrates a decisional operation that may be applied to the Reward Seeker card holder category described above. As will be appreciated, the steps focus on the use of the member profile 26 and card profile 22 information which is associated with the database 14.

At step 100, the financial system is established or provided. Generally, the financial system will be established by a third party entity (from the customer). It is noted that such an entity may be a bank or other credit lender who also offers specific cards or accounts, one or more of which the customer has. Customers wishing to take advantage of the benefits offered by the financial system may register their existing credit cards/accounts, as at step 105. As indicated above, this step may include the step of receiving an storing customer and associated account information.

Preferably, this registration results in the creation of a member profile, as at step 110, and a card criteria profile, as at step 115. While the operational flow diagram generally illustrates steps 110 and 115 as occurring substantially simultaneously, it can be appreciated that these steps may occur at different times.

Once a customer has registered and joined the system as a member, as at step 120, in a preferred embodiment, a master financial account and associated card are created for the customer. The master financial card is issued to the customer/member. As stated above, it is contemplated that the master financial card may be used for all credit transactions.

Referring to step 125, a customer/member presents the master financial card at the point of purchase. Through the types and means of communication that are known in the art, the purchase event is communicated to the host server, as at step 130. It will be appreciated that while it is preferred that the customer use a master financial card, the customer/member may utilize any card or account.

At step 135, the decision processor consults the hierarchy of use-consequence preference information in the member profile of the database. At this point, as at step 140, an inquiry is made as to whether a first choice card/account in the hierarchy of choices is applicable to this purchase transaction. If so, then at step 145, the purchase is applied to the first choice card/account. If not, the decision processor consults the hierarchy of choices for the next choice card/account as at step 150.

A variety of criteria may be applied in determining whether a card is applicable to a transaction. Such criteria may include whether or not the card is accepted by the retailer or other vendor where the transaction is occurring, whether there is any available credit, or other criteria.

A new inquiry is made at step 155 as to whether the next choice card/account is applicable to the purchase transaction. If the next choice card/account is applicable for the purchase, then at step 160 the decision processor applies the purchase to the next choice card/account. If not, the system repeats at 150 with the decision processor consulting the hierarchy of choices for the next choice card/account. Thus, it can be appreciated that the steps 150 and 155 may be repeated until the proper card/account in the family of cards/accounts possessed by the customer/member is determined and the purchase is applied to that card/account in a final step as at 160.

An alternate method of operation of the financial system is illustrated in the operational flow diagram presented in FIGS. 3 and 3A. This operational flow diagram may be primarily used by those in the card holder categories described above as Credit Users and Debt Reducers. As stated above, the primary concern of these consumers in using credit accounts is to use the account which maximizes their credit availability and minimizes their monetary outlay. In this respect, the information in the card criteria profile 22 is the important information in the decision-making process when a credit transaction occurs.

The initial steps in this operational flow diagram are identical to the steps described in the previous operational diagram. More particularly, at step 200, the financial system is established. At step 205, the customer registers all of his or her credit accounts with the financial system and acts to join the system. As stated above, upon registration, a member profile 210 and a card criteria profile 215 are created and stored in the database of the financial system. Also as stated above, it can be appreciated that the steps of creating the member profile and the card criteria profile may occur either substantially simultaneously as shown, or at different times.

At step 220, a master financial card may be issued to the customer/member. When the customer/member desires to make a credit purchase, at step 225, the customer/member may present that or another card. Through communication procedures known in the art, at step 230, the purchase event is communicated to the host server of the financial system.

At step 235, the decision processor of the host server determines the optimum criteria from the card criteria profile that is likely to optimize the customer/member's credit resources with regard to this particular transaction. In conjunction with this determination, at step 240, the best card/account is identified to make the particular purchase. Then at step 245, the charge is applied to that best card/account.

In making a large purchase, there may be circumstances when there is insufficient credit associated with any single individual credit account, and in particular the best card account, to cover the purchase. Thus, the purchase may have to be split among two or more individual credit accounts. In this circumstance, at step 250, an inquiry is made as to whether there is any remaining balance to the charge that has not been covered by the best card/account. If there is no remaining balance and the best card/account has covered the entire transaction, then at step 255 the transaction is considered complete. If there is a remaining balance that needs to be charged to another card/account, at step 260, the decision processor identifies the next best card/account for use in the transaction. At step 265, an additional amount of the purchase is applied to the identified next best card/account.

A further inquiry is made at step 270 as to whether there is still any remaining balance of the charge that has not been covered by the first two cards/accounts. If not, the system reverts to step 255 and the transaction is considered complete. If there is a remaining balance, the system repeats step 260 for the decision processor to identify the still next best card/account. Thus, it can be appreciated that steps 260, 265 and 270, along with the related step 255, may be repeated until the transaction is final.

The financial system may offer various other services. The financial system may include a free service that allows consumers to enroll their credit accounts to allow them to personally perform “what-if” scenarios on a web site to determine which card to use for a specific purpose. This free service may also allow the consumer to determine which account to focus payments towards in order to best reduce debt. It is noted that this service provides purchase information to the consumer, but does not automatically facilitate a transaction (thus requiring that the user actually select and use the best card or account at the point of purchase).

As indicated, in a preferred embodiment, a customer is issued a master financial card. The customer's use of that card or account facilitates credit management or selection, such as based upon rewards and payment terms. Additional services that may be provided with full commercial use of the financial system may include credit file alerts, credit counseling, travel notification, and card cancellations.

In addition, it is contemplated that by registering with the financial system, customer/members will be opted out of the pre-approved marketing lists that are kept by the credit reporting agencies. As a result, all credit solicitations may be directed to the financial system rather than to the individual member himself or herself. This benefits the customer/member in that the financial system is configured to best be able to properly manage the credit solicitations in a manner that best suits the customer/member's needs and interests, as the credit offers are matched with membership profiles. The financial system may provide an analysis especially for members who are interested in getting out of debit.

The financial system may also provide benefits to credit issuers. More particularly, it is contemplated that the financial system may be configured to provide information regarding how consumers use credit cards/accounts and what motivates a consumer to use one credit card or account over another. Additional information that may be learned through the use of the financial system is whether a consumer may be inclined to use cash, debit or credit for any particular purchase. The use of this information may allow credit issuers to improve their marketing campaigns and more efficiently target consumers for particular rewards that may be offered with their programs.

The financial system may also develop an action profile for customer/members. More specifically, such a profile may be established for those who wish to get out of debt as quickly as possible. A different profile may be established for those customer/members who wish to build and/or improve their credit rating. The debt reduction profile may comprise the assurance that payments will be made on a timely bases, with the payments directed to the credit accounts that most quickly accelerate debt reduction. The credit building profile may comprise developing a strategy to pay down on accounts whose balance are close to their credit limits, as opposed to a decision to pay down on accounts having the highest APR.

In one embodiment, the various cards or accounts which the user may associate with the system may include not only “credit” accounts, but debit accounts. For example, a user may associate their debit bank card. A purchasing decision may thus include a determination of whether it is best to use the customer's cash, via the debit card, rather than use credit.

In one embodiment, the financial system 10 may be configured to receive information from third party credit issuers. For example, a customer's card profile may be updated with new card or account related information. During a particular period of time, a card issuer may offer a particular reward program, such as double points for purchases made from a particular retailer. That information may be updated to the customer's profile so that if the customer makes a purchase from such a retailer, the bonus reward information may be known and utilized in making the purchasing decision.

In summary, the financial system of the present invention is designed to eliminate the on-the-spot decision-making process for the consumer when making a credit purchase. The financial system preferably utilizes card criteria and use-consequence preference information to either provide decision information or automatically decide which among the customer/member's credit cards/accounts is the optimum or preferred credit card/account to which to apply a credit transaction. This allows a customer/member to most efficiently optimize his or her credit resources. Additional points of functionality that result from the advantages of the invention may include interest change alerts, fraud alerts based on customer preferences, a one-site viewing location for total outstanding monthly credit obligations, consolidation of information relating to card holder benefits and the creation of debt profiles to minimize the chance for a consumer to overextend on credit purchases. The system may also be configured to select certain merchants to override a preference profile to automatically direct certain purchases to a business credit card rather than a personal credit card or to always force double dipping when they are available through a rewards program, such as always using an airline-sponsored credit card when making airline ticket purchases.

The foregoing description of a preferred embodiment of the invention has been presented for purposes of illustration and description. It is not intended to be exhaustive or to limit the invention to the precise form disclosed. Obvious modifications or variations are possible in light of the above teachings. The embodiment disclosed herein was chosen and described to provide the best illustration of the principles of the invention and its practical application to thereby enable one of ordinary skill in the art to utilize the invention and its various embodiments and with various modifications as is suited to the particular use contemplated. All such modifications and variations are within the scope of the invention as determined by the appended claims when interpreted in accordance with the breath to which they are fairly, legally and equitably entitled.

What is claimed is:

1. A financial system for optimizing the use of credit resources, comprising:
a database for receiving and storing information regarding one or more credit accounts and the use-consequence preference information of a customer;
a master financial card for use for credit transactions; and
a decision processor that communicates with said database and said master financial card when said master financial card is used for a credit transaction,
whereby said decision processor decides the optimum credit account of said customer to which to apply said credit transaction.

2. The system in accordance with claim 1 wherein at least one of said credit accounts comprises a debit account.

3. The system in accordance with claim 1 wherein said at least one credit account comprises a bank account.

4. The system in accordance with claim 1 wherein said at least one credit account comprises at least one debit account and at least one bank account.

5. The system in accordance with claim 1 wherein said master financial card is selected from the group consisting of: a magnetic stripe card, an RFID device and a smart card.

6. The system in accordance with claim 1 wherein said information regarding one or more credit accounts comprises account numbers identifying each account.

7. The system in accordance with claim 1 wherein said information regarding one or more credit accounts comprises information selected from the group consisting of: annual percentage rate, payment schedule, account balance, minimum payment terms, service fees, cash back awards, mileage awards and point awards.

8. The system in accordance with claim 1 wherein said use-consequence preference information comprises a hierarchy of said one or more credit accounts.

9. The system in accordance with claim 1 wherein said use-consequence preference information comprises information identifying said customer as a credit user, debt reducer or reward seeker.

10. A method for optimizing the use of credit resources, comprising the steps of:
establishing a financial system, hosted by a server configured to manage a plurality of credit accounts for a customer;
providing information regarding one or more credit accounts of said customer to said financial system;
providing use-consequence preference information for said customer to said financial system;
issuing a master financial card for use for credit transactions;
communicating use of said master financial card for a credit transaction to said host server; and
configuring said host server to decide the optimum credit account of said customer to which to apply said credit transaction.

12. The method in accordance with claim 10 wherein at least one of said credit accounts comprises a debit account.

13. The method in accordance with claim 10 wherein said at least one credit account comprises a bank account.

14. The method in accordance with claim 10 wherein said at least one credit account comprises at least one debit account and at least one bank account.

15. The method in accordance with claim 10 wherein said master financial card is selected from the group consisting of: a magnetic stripe card, an RFID device and a smart card.

16. The method in accordance with claim 10 wherein said information regarding one or more credit accounts comprises account numbers identifying each account.

17. The method in accordance with claim 10 wherein said information regarding one or more credit accounts comprises information selected from the group consisting of: annual percentage rate, payment schedule, account balance, minimum payment terms, service fees, cash back awards, mileage awards and point awards.

18. The method in accordance with claim 10 wherein said use-consequence preference information comprises a hierarchy of said one or more credit accounts.

19. The method in accordance with claim 10 wherein said use-consequence preference information comprises information identifying said customer as a credit user, debt reducer or reward seeker.
